(19) United States
(12) Patent Application Publication
(10) Pub. No.: US 2025/0315694 A1
(43) Pub. Date: Oct. 9, 2025

(54) GENERATING A KNOWLEDGE GRAPH

(71) Applicant: Telefonaktiebolaget LM Ericsson (publ), Stockholm (SE)

(72) Inventors: Carmen LEE ALTMANN, Täby (SE); Jalil TAGHIA, STOCKHOLM (SE); Niklas WAHLSTRÖM, UPPLANDS VÄSBY (SE)

(73) Assignee: Telefonaktiebolaget LM Ericsson (publ), Stockholm (SE)

(21) Appl. No.: 18/707,403

(22) PCT Filed: Nov. 4, 2021
(86) PCT No.: PCT/EP2021/080629

§ 371 Date: May 3, 2024

(51) Int. Cl. G06N 5/022; G06N 3/0455

(52) U.S. Cl. CPC G06N 5/022; G06N 3/0455

(57) ABSTRACT

A computer implemented method for generating a Knowledge Graph (KG) representing relationships between a plurality of Machine Learning (ML) tasks relating to a computing infrastructure. The method comprises constructing a plurality of nodes representing the plurality of ML tasks. The method further comprises constructing a plurality of edges forming an edge graph and connecting the nodes among the plurality of nodes. The construction of the plurality of edge comprises: applying an encoder ML model to the plurality of nodes to generate an initial edge graph, applying a decoder ML model to the initial edge graph to output reconstructions of ML tasks, calculating a loss function, evaluating the determined loss function using a convergence criterion, and, on satisfaction of the convergence criterion, outputting a final edge graph.

### TECHNICAL FIELD

The present disclosure relates to a computer implemented method for generating a Knowledge Graph (KG) representing relationships between a plurality of Machine Learning (ML) tasks relating to a computing infrastructure. The method may be performed by a computing apparatus, and the present disclosure also relates to a computing apparatus and to a computer program product configured, when run on a computer, to carry out a method for generating a KG representing relationships between a plurality of ML tasks relating to a computing infrastructure.

### BACKGROUND

As ML advances, the complexity and size of ML models increases. A natural consequence of increased ML model size and complexity is increased training requirements, that is, the resource requirements (including processing resources, power resources, time resources, training data resources, and so on) to train a ML model are likely to be higher for larger and more complex models. Where ML models are to be used in areas such as communication networks or data centres, it may not be feasible to train ML models from a zero (completely untrained) state due to computational limitations, time constraints or lack of training data. Accordingly, it may be advantageous or necessary to provide means for shortening training processes. Existing training of a ML model may be reapplied into a related domain or onto a related task by using the trained (or partially trained) ML model parameters as the starting point for training a new model, as is the case where transfer learning is used. Alternatively, ML models may be trained for multitask use from the outset of model design as in the case of few-shot learning and multitask learning.

A common factor where fully or partially trained ML models are to be reused is that the selection of source and target tasks is key. In the context of transfer learning, the term source task refers to the task whose model parameters (such as weights) are to be used to provide a model (or initialization parameters for model training) for a further task; the further task in this context is the target task. Similarly, in few shot learning, the model has been pretrained on a set of source tasks. Upon analysing a small number of examples of the target task (that is, a smaller number of examples than would be required to train the model from a zero state), the model can quickly specialise in the target task and perform relatively well. Knowledge of the relationships between tasks can also be valuable where it is not (necessarily) intended to reuse a fully or partially trained ML model, for example, in distributed learning systems such as federated learning systems where knowing which tasks are similar can help selection of participating ML agents for the federation; ML agents that share similar tasks space can more effectively collaborate with each other than those performing disparate tasks.

Typically, the identification of related tasks, such as source and target tasks in the context of transfer learning, relies on domain knowledge from human domain experts. In most situations, the selection of related tasks is necessarily performed separately on a case-by-case basis. Accordingly, the identification of related tasks may be time consuming and difficult to automate. Techniques for evaluating the suitability of identified related tasks, such as the suitability of a selected source task for a given target task or the suitability of a selected group of agents to federate, typically rely on posterior analysis. As an example of this, the performance of a ML model that has been obtained using transfer learning at a given task may be compared to the performance at the same task of a ML model that has been trained without using transfer learning (from a zero state), and the suitability of the selection of source task may be measured based on this performance. New tasks or transfers which have not previously been evaluated typically cannot benefit from posterior analyses.

### SUMMARY

It is an aim of the present disclosure to provide a method, a computing apparatus, and a computer program product which at least partially address one or more of the challenges discussed above. It is a further aim of the present disclosure to provide method, a computing apparatus, and a computer program product that may allow a reduction in the amount of human input when selecting, for example, ML models for federation, source ML models for transfer learning, and so on. It is a further aim of the present disclosure to provide method, a computing apparatus, and a computer program product that may mitigate the impact of ML model failures and/or may support determination of relationships between tasks free from the influence of ML models used to perform said tasks.

An embodiment of the present disclosure provides a computer implemented method for generating a KG representing relationships between a plurality of ML tasks relating to a computing infrastructure. Each ML task among the plurality of ML tasks is characterised by an input data set and an output data set, and each ML task among the plurality of ML tasks utilises the same input data set. The method comprises constructing a plurality of nodes representing the plurality of ML tasks, wherein each of the ML tasks among the plurality of ML tasks is characterised by the input data set to the ML task and an output data set from the ML task. The method further comprises constructing a plurality of edges forming an edge graph and connecting the nodes among the plurality of nodes, wherein the construction of the plurality of edges comprises: applying an encoder ML model to the plurality of nodes, wherein the encoder ML model processes the nodes among the plurality of nodes in turn in a pairwise fashion and outputs an initial edge graph that represents the relationships between the pairs of nodes; applying a decoder ML model to the initial edge graph, wherein the decoder ML model processes the initial edge graph in conjunction with input data and outputs reconstructions of ML tasks; calculating a loss function using known ML tasks corresponding reconstructed ML tasks; and
evaluating the determined loss function using a predetermined convergence criterion. If the convergence criterion is not satisfied, the method comprises updating parameters of the encoder ML model and decoder ML model to minimise a value of the loss function and reapplying the encoder ML model and decoder ML model. The method further comprises, on satisfaction of the convergence criterion, outputting a final edge graph as the KG comprising the constructed edges.

A further embodiment of the present disclosure provides a computing apparatus configured to generate a KG representing relationships between a plurality of ML tasks relating to a computing infrastructure, wherein each ML task among the plurality of ML tasks is characterised by an input data set and an output data set, and wherein each ML task among the plurality of ML tasks utilises the same input data set. The computing apparatus comprises processing circuitry and a memory containing instructions executable by the processing circuitry. The computing apparatus is operable to construct a plurality of nodes representing the plurality of ML tasks, wherein each of the ML tasks among the plurality of ML tasks is characterised by the input data set to the ML task and an output data set from the ML task. The computing apparatus is further operable to construct a plurality of edges forming an edge graph and connecting the nodes among the plurality of nodes. In the construction of the plurality of edges, the computing apparatus is operable to: apply an encoder ML model to the plurality of nodes, wherein the encoder ML model processes the nodes among the plurality of nodes in turn in a pairwise fashion and outputs an initial edge graph that represents the relationships between the pairs of nodes; apply a decoder ML model to the initial edge graph, wherein the decoder ML model processes the initial edge graph in conjunction with input data and outputs reconstructions of ML tasks; calculate a loss function using known ML tasks corresponding reconstructed ML tasks; and evaluate the determined loss function using a predetermined convergence criterion. If the convergence criterion is not satisfied, the computing apparatus is operable to update parameters of the encoder ML model and decoder ML model to minimise a value of the loss function and reapply the encoder ML model and decoder ML model. The computing apparatus is further operable to, on satisfaction of the convergence criterion, output a final edge graph as the KG comprising the constructed edges.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flowchart showing a method in accordance with embodiments;

FIG. 2A is a schematic diagram of a computing apparatus in accordance with embodiments;

FIG. 2B is a schematic diagram of a further computing apparatus in accordance with embodiments;

FIG. 3 is a figurative illustration of the tasks and edges;

FIG. 4 is a schematic diagram showing the development and use of an output KG in accordance with embodiments;

FIG. 5 is a schematic diagram of the development and use of an output KG to infer unknown values in accordance with embodiments; and

FIG. 6A, FIG. 6B and FIG. 6C are schematic diagrams illustrating the development of an output KG in accordance with embodiments.

### DETAILED DESCRIPTION

In some situations, human domain experts may create Knowledge Graphs (KG) when identifying related tasks. KG created by human domain experts may express the relationships between use-cases and may be used to facilitate construction of a new use case. Creation of KG by human domain experts may be costly, and the created KG may be subjective, as the KG are based on direct feedback from the domain expert. Accordingly, it is desirable to provide means for generating KG with reduced human domain expert input.

Embodiments of the disclosure may provide methods, computing apparatuses and computer programs for obtaining KG that represent relationships between ML tasks, wherein the ML tasks relate to a computing infrastructure such as a communication network (for example, all or part of a 3^{rd} Generation Partnership Project, 3GPP, communication network), data centre, and so on. In order to obtain a KG representing relationships between ML tasks, embodiments may represent tasks as nodes on the KG. Each of the tasks may take the same input data set, but map to domains that are different (overlapping or disjoint). That is, each of the tasks may be characterised by an input data set (that is the same as the input data sets of the other tasks represented on the KG) and a task specific output data set. The relations between nodes may be modelled as bidirectional connections, in which the head is the sending node, and the tail is the receiving node in message passing. The message passed is weighted by the magnitude of the connection.

As will be appreciated by those skilled in the art, the nature of the tasks represented on the KG is dependent on the computing infrastructure to which the tasks relate. Where the computing infrastructure is all or part of a communication network, as discussed above, tasks may relate to predicting future capacity of the network, estimating network latency, and so on. Where the computing infrastructure is a data centre, tasks may relate to predicting power usage, estimating available memory or processing resources at a future time, and so on. As mentioned above, each of the tasks may have the same input data set; this data set comprises values for a number of metrics that represent a state of the computing infrastructure (for example, the current state of the computing infrastructure).

Returning to the example in which the computing infrastructure is all or part of a communication network, the metrics may indicate the current available capacity of one or more base stations (which may be 4^{th} Generation, 4G, Evolved Node Bs, eNB, or 5^{th} Generation, 5G, next Generation Node Bs, gNBs, for example), the amount of data in the base station buffers for onward transmission, the number of user equipments (UEs) connected to given base stations, and so on. The exact metrics used by a given task may be dependent on the nature of the task, however further examples which may be of use in embodiments in which the computing infrastructure is some or all of a communications network include: a value of a network coverage parameter; a value of a network capacity parameter; a value of a network congestion parameter; a current network resource allocation; a current network resource configuration; a current network usage parameter; a current network parameter of a neighbour communication network cell; a value of a network signal quality parameter; a value of a network signal interference parameter; a value of a network power parameter; a current network frequency band; a current network antenna down-tilt angle; a current network antenna vertical beamwidth; a current network antenna horizontal beamwidth; a current network antenna height; a current network geolocation; and so on.

Taking the example in which the computing infrastructure is a data centre, the metrics may include some or all of those listed above in the context of a communications network, and also data centre specific metrics such as the current capacities of processors, whether processors are operating correctly or not, current total storage capacity, current free storage capacity, and so on. The input data may be obtained in any suitable way depending on the facilities available for a given computing infrastructure, for example, may be obtained from different network nodes, from sensors in a data centre, from counters or logs at the individual devices, through packet monitoring, and so on.

The tasks have output data sets that differ from one another (these output data sets may overlap or may be entirely separate), for example, a task predicting future network capacity would have an output data set comprising capacity values, while a task estimating future latencies would have an output data set comprising latency values.

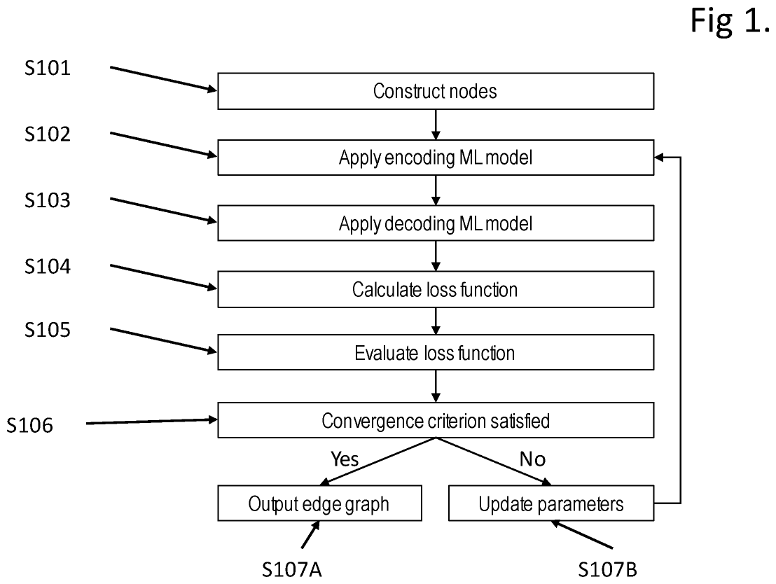

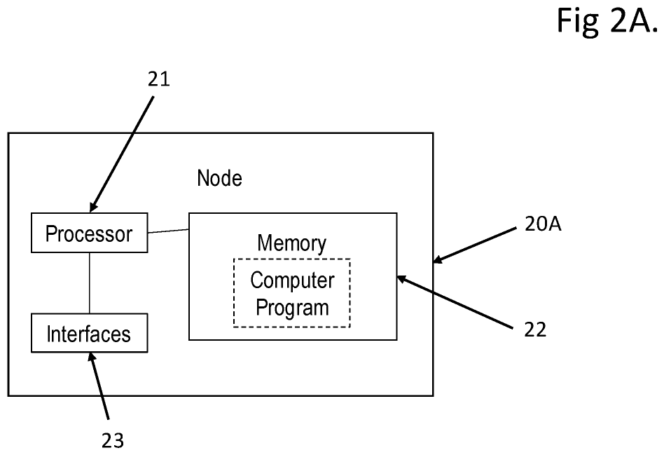

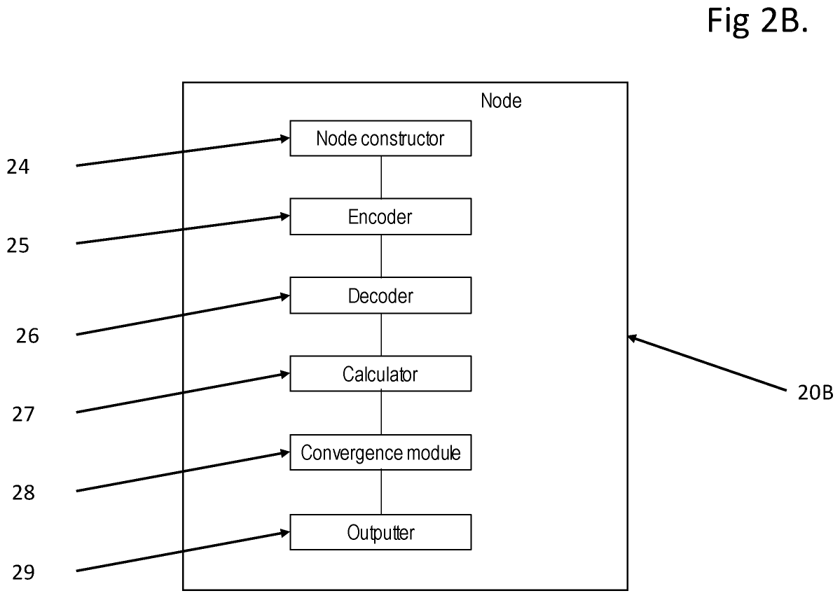

FIG. 1 is a flowchart showing a method in accordance with embodiments. The method may be performed by any suitable apparatus. Examples of suitable apparatus for performing the method shown in FIG. 1 are the computing apparatuses 20A and 20B shown schematically in FIG. 2A and FIG. 2B respectively; the computing apparatuses 20A and 20B may collectively be referred to using reference sign 20. The method may also be performed by any other suitable component or components, such as a further component of the computing infrastructure. The computing apparatuses 20 may be, for example all or part of core network nodes, base stations or data centre controllers, and/or may be hosted in cloud computing systems. The computing apparatus 20A as shown in FIG. 2A may execute steps of the method in accordance with a computer program stored in a memory 22, executed by a processor 21 in conjunction with one or more interfaces 23. The computing apparatus 20B as shown in FIG. 2B may execute steps of the method using node constructor 24, encoder 25, decoder 26, calculator 27, convergence module 28 and outputter 29. The computing apparatuses 20A and 20B may also be configured to execute the steps of other embodiments, as discussed in detail below.

As shown in step S101 of FIG. 1, the method comprises constructing a plurality of nodes representing the plurality of ML tasks, wherein each of the ML tasks among the plurality of ML tasks is characterised by the input data set to the ML task and an output data set from the ML task. Given the set of ML tasks τ={τ₁, τ₂, . . . τₙ}, each ML task represents a transformation from the input x (which, as discussed above, is a data set comprising values for a number of metrics) to the respective ML task output y_i, i∈{1, 2, . . . n}. The pair of inputs and outputs for the use case i is vᵢ=(x, y_{τ}_{ᵢ}) which corresponds the i-th node on the KG. For each of the ML tasks, a node is constructed in the KG. Where a computing apparatus 20A in accordance with the embodiment shown in FIG. 2A is used, the construction of the nodes may be performed in accordance with a computer program stored in a memory 22, executed by a processor 21 in conjunction with one or more interfaces 23. Alternatively, where a computing apparatus 20B in accordance with the embodiment shown in FIG. 2B is used, the construction of the nodes may be performed by the node constructor 24.

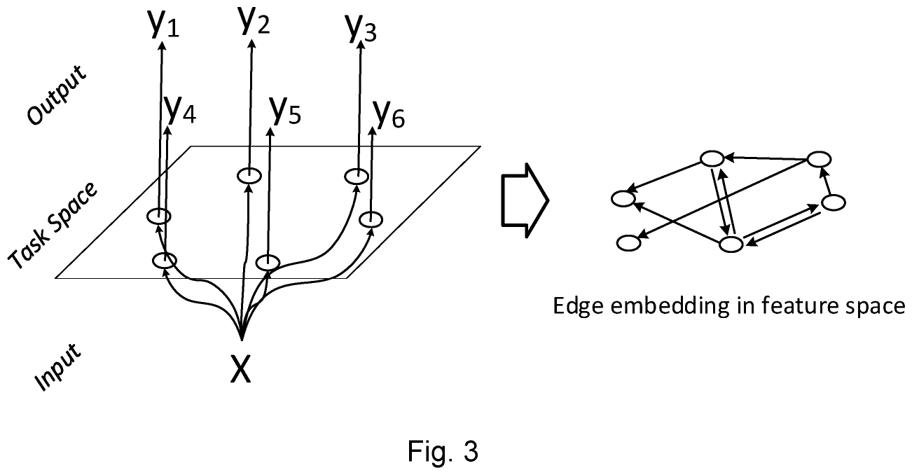

Following the population of the KG with nodes representing the tasks, the method continues with the construction of a plurality of edges connecting the nodes among the plurality of nodes, wherein the plurality of edges collectively form an edge graph. The edges are indicative of the strength of the mapping between nodes; the edge between nodes i and j may be defined as h_{(i,j)}. A figurative illustration of the tasks and edges is shown in FIG. 3. In FIG. 3, the left portion of the figure shows input data X being processed by tasks 1 to 6 (represented by circles in the task space) to generate respective outputs Y₁ to Y₆. The embedding of the edges between the tasks is shown on the right portion of the figure.

The process for obtaining the edges relies on the assumption that that tasks are represented by their underlying models ƒ_{τ}_{ᵢ}, where ƒ is a idealised function parameterized by θ such that ƒθ: X→Y. In the same way that the input space X can be mapped to an output space Y_{τ}_{ᵢ}, using function ƒ_{τ}_{ᵢ}, there exists a mapping from output space Y_{τ}_{ᵢ} to output space Y_{τ}_{ⱼ} and vice versa. Using this information and given a sample of input data x and output data y_{τ}_{ᵢ}, it is possible to fully recover y_{τ}_{ⱼ} if the mapping is bijective (that is, if there is a 1:1 reversible mapping) and partially recover y_{τ}_{ⱼ} if the mapping is not bijective.

In order to obtain the plurality of edges between the nodes (such as edge h_{(i,j)}, the edge between tasks (nodes) vᵢ and vⱼ) in the KG, a multistep process is used. The process functions by training an encoder and a decoder to generate accurate edges.

In the first step of the process for obtaining the edges between nodes, as shown in step S102 of FIG. 1, an encoder ML model is applied to all of the ML tasks in the KG in a pairwise fashion. As an example of the pairwise application of the encoder ML model, if the KG contained three tasks A, B and C, the ML model would process pair of ML tasks A and B together and output edge h_{(A,B)}, process pair of ML tasks A and C together and output edge h_{(A,C)}, and process pair of ML tasks B and C together and output edge h_{(B,C)}. The output of the encoder ML model is an initial edge graph representing the relationships between the pairs of nodes (ML tasks), as shown diagrammatically in the right portion of FIG. 3. In some embodiments, the encoder ML model may be a Graphical Neural Network (GNN) encoder ML model; this form of encoder ML model may be particularly well suited to edge derivation as discussed herein.

An example of an encoder ML model (which is a GNN encoder model) is characterized by the equations shown below, where

$${f}_{e}^{1} and {f}_{e}^{2}$$

are nonlinear functions which take node representations as inputs and produce the edge relations while

$${f}_{v}^{1}$$

is the nonlinear function which takes the edges as inputs and produces node representations. The nonlinear functions may be in the form of neural networks or any other differentiable models. The output layer is a softmax function which takes as inputs the edge relations and normalize them into a probability distribution. The set ϕ includes all differentiable parameters to be trained during the training process.

$$v \to e : {h}_{( i , j )}^{1} = {f}_{e}^{1} ( {v}_{i}^{1} , {v}_{j}^{1} )$$

$$e \to v : {h}_{j}^{2} = {f}_{v}^{1} ( {\sum }_{i \neq j} {h}_{( i , j )}^{1} )$$

$$v \to e : {h}_{( i , j )}^{2} = {f}_{e}^{2} ( {h}_{i}^{2} , {h}_{j}^{2} )$$

$${q}_{ϕ} ( {z}_{ij} \vert v ) = softmax ( {h}_{i , j}^{2} )$$

Where a computing apparatus 20A in accordance with the embodiment shown in FIG. 2A is used, the application of the encoder ML model to the pairs of nodes to derive edges may be performed in accordance with a computer program stored in a memory 22, executed by a processor 21 in conjunction with one or more interfaces 23. Alternatively, where a computing apparatus 20B in accordance with the embodiment shown in FIG. 2B is used, the application of the encoder ML model to the pairs of nodes to derive edges may be performed by the encoder 25.

The output from the encoder ML model is a plurality of edges, collectively forming an initial edge graph representing the relationships between the pairs of nodes in the KG. In the next step of the multistep edge derivation process, a decoder ML model is applied to this initial edge graph. Similarly to the case with the encoder ML model, the decoder ML model may be a GNN decoder ML model; GNN decoder ML models may be particularly well suited to this role.

The operations performed by the decoder ML model are essentially the reverse of the operations performed by the encoder ML model. The decoder ML model takes the initial edge graph and processes the initial edge graph in conjunction with input data x; the output of the decoder ML model is a plurality of reconstructions of the tasks \hat{v}. The reconstruction \hat{v} is a reconstruction of task v. In some embodiments, the input data x is the same input data as has been previously input into the encoder ML model; where this is the case, the outputted reconstructions are reconstructions of the tasks originally inputted into the encoder ML model. In alternative embodiments, the input data x that is input into the decoder ML model may be related to but not the same as the input data used by the encoder ML model; an example of this scenario is where the input data into the encoder ML model relates to a first time period and the input data into the decoder ML model relates to a second time period that is not the same as the first time period; the input data into the encoder ML model may be values for a number of metrics that represent a state of the computing infrastructure at time t, while the input data into the decoder ML model may be values for the metrics at time t+10 minutes, for example. The use of different input data into the encoder and decoder ML models in embodiments is discussed in greater detail below. Where the input data into the decoder ML model is the same as the input data into the encoder ML model, the reconstructions output by the decoder ML model are of the tasks input into the encoder ML model.

An example of a decoder ML model (which is a GNN decoder model) is characterised by the equations shown below, where zᵢⱼ is a stochastic sample vector from q_{ϕ}(zᵢⱼ|x) which is a sample from a Concrete distribution. Concrete distributions are discussed in greater detail in “The Concrete Distribution: A Continuous Relaxation of Discrete Random Variables” by Maddison, C., J., Mnih, A. and Teh, Y. W., ICLR 2017, available at https://arxiv.org/abs/1611.00712 as of 6 Oct. 2021. The notation Z_{ij,k} is used to denote the k-th element of zᵢⱼ.

$${z}_{ij} = Concrete ( {h}_{( i , j )}^{2} )$$

$$v \to e : {\tilde{h}}_{( i , j )} = {\sum }_{k} {z}_{ij , k} {\tilde{f}}_{e}^{k} ( {x}_{i} , {x}_{j} )$$

$$e \to v : {μ}_{j} = {\tilde{f}}_{v} ( {\sum }_{i \neq j} {\tilde{h}}_{( i , j )} )$$

$${p}_{θ} ( {x}_{j} \vert z ) = N ( {μ}_{j} , {σ}^{2} I )$$

In the above equations, function

$${\tilde{f}}_{e}^{k}$$

constructs edge relations while function \tilde{ƒ}ᵥ constructs node representations; both are nonlinear functions which are differentiable such as neural networks (for example). The output layer is a Gaussian distribution parameterized by the mean μⱼ learned from the previous layer and a variance which could be fixed or alternatively learned from data. A sample from the Gaussian distribution would provide the reconstructed version of the node representations, \hat{v}ⱼ. The set θ includes all differentiable parameters to be trained during the training process.

Where a computing apparatus 20A in accordance with the embodiment shown in FIG. 2A is used, the application of the decoder ML model to the initial edge graph may be performed in accordance with a computer program stored in a memory 22, executed by a processor 21 in conjunction with one or more interfaces 23. Alternatively, where a computing apparatus 20B in accordance with the embodiment shown in FIG. 2B is used, the application of the decoder ML model to the initial edge graph may be performed by the decoder 26.

Following the application of the encoder ML model and decoder ML model, the multistep process then continues with the calculation of a loss function using known ML tasks and corresponding reconstructed ML tasks, as shown in step S104 of FIG. 1. The loss function outputs the loss between the node representations vᵢ input into the encoder ML model and the output reconstructions from the decoder ML model. In some embodiments, the loss function (l) may comprise a reconstruction loss (l_{rec}) and a regularization loss (l_{reg}), such that l=l_{rec}+l_{reg}. Where the loss function comprises a reconstruction loss (l_{rec}) and a regularization loss (l_{reg}), the equations used to calculate these losses may be chosen based on a variety of factors as will be familiar to those skilled in the art, for example: the distribution, the encoder ML model used, the decoder ML model used, and so on. Examples of equations for the reconstruction loss (l_{rec}) and regularization loss (l_{reg}), are shown below, where μⱼ and σ² are the mean and variance of p_{θ}(x|z), and q_{ϕ}(z|x) is the encoder and p_{θ}(z) denotes the distribution of the edges.

$${ℓ}_{rec} = - {\sum }_{j} \frac{{‖ {x}_{j} - {μ}_{j} ‖}^{2}}{2 {σ}^{2}}$$

$${ℓ}_{reg} = {\sum }_{i \neq j} KL [ {q}_{ϕ} ( z \vert x ) ‖ {p}_{θ} ( z ) ]$$

In some embodiments, the loss function may be calculated by a specific loss calculator module. Essentially, the loss function indicates how accurately the reconstructed tasks reconstruct the original inputted tasks. Where a computing apparatus 20A in accordance with the embodiment shown in FIG. 2A is used, the calculation of the loss function may be performed in accordance with a computer program stored in a memory 22, executed by a processor 21 in conjunction with one or more interfaces 23. Alternatively, where a computing apparatus 20B in accordance with the embodiment shown in FIG. 2B is used, the calculation of the loss function may be performed by the calculator 27.

When the loss function has been calculated, the process then continues with the evaluation of the loss function to determine whether or not a convergence criterion has been satisfied, as shown in step S105 of FIG. 1. In some embodiments a convergence module may be used to evaluate the loss function. In some embodiments, the evaluation of the loss function may utilise previous values of the loss function, in particular, an amount of change in the loss function between the current value of the loss function and previous value of the loss function is compared to a predetermined threshold when determining whether the convergence criterion is satisfied. In alternative embodiments, the value of the loss function itself may be directly compared against a threshold, without the use of previous values of the loss function. In embodiments where the previous value of the loss function is utilised, the first time a loss function is calculated (when there is no previous value of the loss function to use in a comparison), the loss function may be automatically taken to not satisfy the convergence criterion. In some embodiments, additional previous values of the loss function may be used when determining if the convergence criterion is satisfied, for example, if the difference between a calculated loss value and a previous loss value is below a given threshold for a certain number of iterations of the encoding-decoding-loss value calculation process, then the convergence criterion may be considered satisfied.

Where a computing apparatus 20A in accordance with the embodiment shown in FIG. 2A is used, the evaluation of the loss value against the convergence criterion may be performed in accordance with a computer program stored in a memory 22, executed by a processor 21 in conjunction with one or more interfaces 23. Alternatively, where a computing apparatus 20B in accordance with the embodiment shown in FIG. 2B is used, the evaluation of the loss value against the convergence criterion may be performed by the convergence module 28.

The next step of the process is dependent on the result of the loss value evaluation. If the convergence criterion is not considered to be satisfied, this indicates that the initial edges of the KG (as have been calculated by the encoder ML model) are not sufficiently accurate for the requirements of the particular implementation. Accordingly, and based on the calculated loss values, the parameters of the encoder ML model and decoder ML model to be trained (for example, the θ and ϕ values as discussed above) are updated with the aim of reducing the loss value (see step S107B of FIG. 1). The process of steps S102 to S106 are then repeated using the updated encoder ML model and updated decoder ML model.

In some embodiments, the updating of the parameters of the encoder ML model and decoder ML model may utilise the calculated loss function in the updating process. The updating process may include computing the gradient of the loss l with respect to all trainable parameters ϕ and θ, shown as ∇l_{ϕ} and ∇l_{θ}. The parameters may then be updated according to ϕ←Optim (ϕ, ∇l_{ϕ}; η)∥1θ←Optim(θ, ∇l_{θ}; η), where Optim(⋅; η) may be any suitable optimizer having parameter set η that includes the learning rate. An example of a suitable optimizer is the Adam optimizer, discussed in detail in “Adam: A Method for Stochastic Optimization” by Kingma, D., P. and Ba, J., L., ICLR 2015, available at https://arxiv.org/abs/1412.6980 as of 6 Oct. 2021.

Where a computing apparatus 20A in accordance with the embodiment shown in FIG. 2A is used, the updating of the parameters of the encoder ML model and decoder ML model may be performed in accordance with a computer program stored in a memory 22, executed by a processor 21 in conjunction with one or more interfaces 23. Alternatively, where a computing apparatus 20B in accordance with the embodiment shown in FIG. 2B is used, the updating of the parameters of the encoder ML model and decoder ML model may be performed by the convergence module 28.

If the convergence criterion is considered to be satisfied, this indicates that the initial edges of the KG (as have been calculated by the encoder ML model) are sufficiently accurate for the requirements of the particular implementation. Accordingly, the initial edge graph may then be outputted as a final edge graph as shown in step S107A of FIG. 1; the final edge graph is a KG comprising the constructed edges. Typically, the constructed nodes are not required for or included in the KG outputted. The encoder ML model and decoder ML model primarily functioned as tools to allow the final KG to be obtained, accordingly once the final KG has been obtained and outputted, the encoder ML model and decoder ML model may no longer be required. Where a computing apparatus 20A in accordance with the embodiment shown in FIG. 2A is used, the outputting of the KG may be performed in accordance with a computer program stored in a memory 22, executed by a processor 21 in conjunction with one or more interfaces 23. Alternatively, where a computing apparatus 20B in accordance with the embodiment shown in FIG. 2B is used, the outputting of the KG may be performed by the outputter 29.

Once outputted the KG may then be utilized. As discussed above, the decoder ML model may use the same input data as the encoder ML model (that is, the input data that is used to generate the nodes), or may use different input data to the encoder ML model. The use of the same input data for the encoder and decoder ML models or different input data may be determined, at least in part, by the intended use of the outputted KG.

Where the decoder ML model uses the same input data as the encoder ML model the outputted KG may be used, for example, to determine relations between ML tasks and in particular to identify closely related ML tasks. The identification of closely related ML tasks can have a variety of applications, prominent among which is in source selection for transfer learning. In transfer learning applications, a ML model that has been trained or partially trained to perform a first ML task may be used as the starting point for training a ML model to perform a second ML task (the second ML task being different to the first ML task); that is, the starting parameters for the ML model to be trained to perform the second task may be taken from the parameters of the ML model trained or partially trained to perform the first task. As explained above, the selection of the first (source) ML model to provide the initialization parameters for the second (target) ML model to be trained is of some importance in the success of transfer learning, if the selected source ML model is not a good match to the task to be performed by the target ML model, the performance of the target ML model when trained is likely to be less good than if a better source ML model had been used to provide the initialization parameters, and in some cases may even be worse than if the target ML model had been trained from a zero state (this may be referred to as negative transfer learning).

Similarity between the tasks to be performed by the source ML model and target ML model is typically indicative of a higher chance of successful transfer learning. Accordingly, in some embodiments, the output KG may be used to identify at least first and second ML tasks that are closely related to one another. Using this identification, where one of the closely related ML tasks has an associated trained or partially trained ML model, this ML model may be used to provide initialization parameters for a further ML model to be trained to perform the other of the closely related tasks. The determination of when two tasks are considered closely related may be made based on the particular properties of a system; in some embodiments, for a given ML task, a closely related ML task may be determined as simply the most similar task to the given ML task. Other embodiments may perform a mathematical comparison of the edges between tasks and apply a similarity threshold to identify closely related tasks.

In some embodiments, the number of closely related ML tasks may be larger than two, Where plural trained or partially trained ML models are associated with tasks among the closely related ML tasks, the parameters from these plural trained or partially trained ML models may be combined (for example, averaged) to provide initialization parameters for further ML model(s) to be trained to perform the tasks among the closely related ML tasks for which no trained or partially trained ML model is available.

In embodiments wherein the computing infrastructure is all or part of a data centre, the identification of related ML tasks using the KG may be used to select among existing ML models to determine a suitable ML model to provide initialization parameters for a further ML model in a transfer learning scenario. As an example implementation of this, in an embodiment where ML models exist to perform the tasks of estimating future power consumption of servers of the data centre and estimating future processing resource availability in the data centre, the outputted KG may be utilized to select the ML model that estimates future processing resource availability as a better source of initialization parameters for a further ML model intended to perform the task of estimating future memory availability than the ML model that estimates future power consumption.

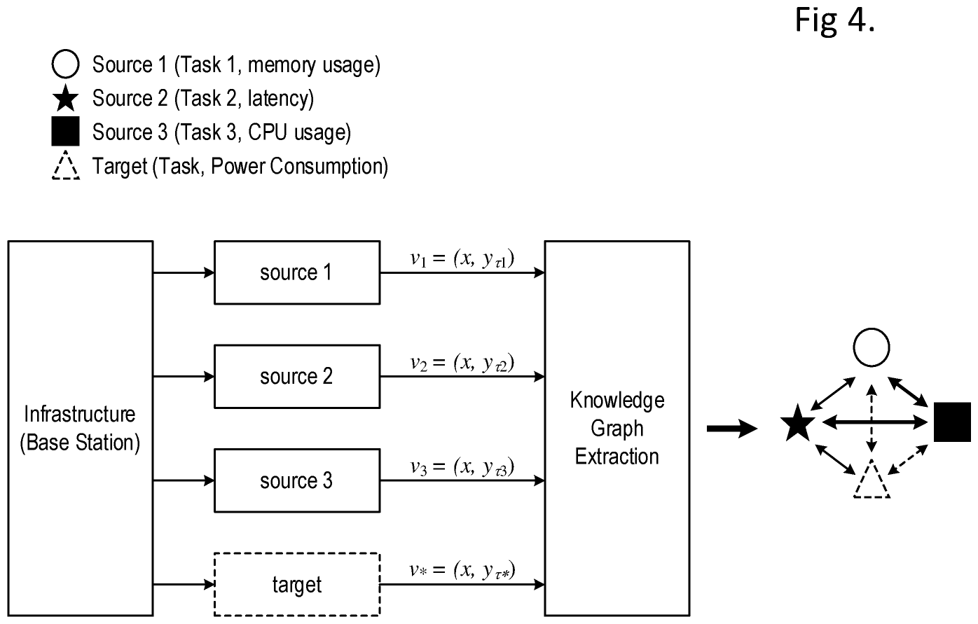

FIG. 4 is a schematic diagram showing the use of an output KG in a further embodiment. In the embodiment shown in FIG. 4, the computing infrastructure to which the ML tasks relate is a plurality of base stations in a communication network. There are four ML tasks relating to the base station: task 1) estimating future memory usage (indicated by a circle in FIG. 4); task 2) estimating future latency (indicated by a star in FIG. 4); task 3) estimating future CPU usage (indicated by a square in FIG. 4); and task 4) estimating future power consumption (indicated by a triangle in FIG. 4). For three of the tasks, specifically tasks 1, 2 and 3, there exist ML models that have been fully or partially trained to perform the tasks. No ML model exists that has been trained to perform task 4. Where transfer learning is to be used to provide initialization parameters for a ML model to be trained to perform task 4 (the target ML model, see the dashed triangle in FIG. 4), a KG comprising an edge graph showing the relations between the four tasks may be generated and used to select ML models to provide the initialization parameters (the one or more source ML models). The generated KG showing the relations between the tasks is shown in FIG. 4; for simplicity the tasks themselves are also shown on the KG using the symbols indicated above. From the KG, it can be deduced that tasks 1 and 3 are closely related to task 4 (indicated by dashed arrows in FIG. 4), and therefore the ML models trained or partially trained to perform tasks 1 and 3 may be used as source ML models providing initialization parameters for the ML model to be trained to perform task 4.

A further application of the identification of closely related ML tasks using the output KG is in federated learning. In federated learning systems, the results of training a plurality of ML models are combined, with the aim of improving the performance of all of the models in the federation. Typically, after a period of training, the parameters of ML models being used by ML agents in the federation will be combined to form an aggregated ML model (for example, by averaging the parameters), which will typically then be distributed back to the ML agents for further training or use. In order to perform effectively, the ML models being federated should be selected, specifically the ML models should be trained to perform similar tasks. If this is not the case, there is an increased risk that the parameters of the ML models will be very different from one another and the aggregated ML model may perform poorly at all of the tasks to be performed by the individual ML models.

Where an output KG is available as discussed above, this KG may be used to select related tasks (and hence ML models trained to perform similar tasks) to be federated. Returning to the example of FIG. 4 and assuming that a ML model has been trained to perform task 4 (such that there is a ML model trained to perform each of the four tasks), the KG could be used to select ML models for federation. From the KG in FIG. 4, it is clear from observing the edges that tasks 1, 3 and 4 are similar to one another, and also clear that task 2 is not similar to any of the other tasks. Accordingly, the KG could be used to determine to federate tasks 1, 3 and 4 in a federated learning system, and to exclude task 2 from the federation.

As discussed above, in some embodiments the input data used by the decoder ML model when processing the initial edge graph is not the same as that used by the encoder ML model to form the initial edge graph. More specifically, in some embodiments, the input data used by the decoder ML model when processing the initial edge graph relates to at least one of the plurality of nodes. Also, the input data used by the decoder ML model relates to a second time period and the input data used in the construction of the plurality of nodes relates to a first time period that is different to the second time period; typically the first time period is earlier in time than the second time period. The decoder ML model may then output reconstructions of the ML tasks relating to the second time period, the accuracy of these reconstructions may be evaluated using a loss function based on known ML tasks relating to the second time period. A purpose of operating over two time periods in this way is to generate an output KG allowing the inference of values for ML tasks relating to the second period, wherein the actual values of the ML tasks for the second period are unknown. The ML task values may be unknown if, for example, the ML model responsible for generating values has ceased to operate correctly between the first time period and the second time period.

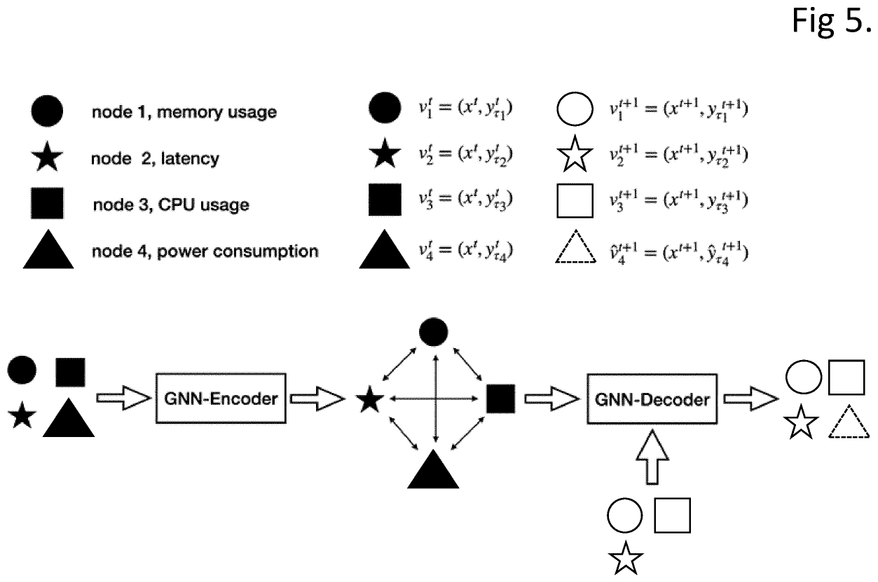

FIG. 5 is a schematic diagram illustrating an example of the use of the KG to infer unknown values as discussed above. The computing infrastructure to which FIG. 5 relates is similar to that to which the embodiment of FIG. 4 relates; again the computing infra structure is a plurality of base stations in a communication network. In the example shown in FIG. 5, each of the ML tasks has an associated ML model that has been trained or partially trained to perform the task. The ML tasks in FIG. 5 are the same as those in FIG. 4: task 1) estimating future memory usage of the base stations (indicated by a circle in FIG. 5); task 2) estimating future latency (indicated by a star in FIG. 5); task 3) estimating future CPU usage (indicated by a square in FIG. 5); and task 4) estimating future power consumption (indicated by a triangle in FIG. 5).

At a first time period (time t) all of the ML models performing the ML tasks are functioning correctly, and the encoder ML model shown in FIG. 5 generates an initial edge graph by processing the pairs of nodes among the plurality of nodes in turn in a pairwise fashion. The nodes used to construct the initial edge graph are therefore

$${υ}_{1}^{t} = ( {x}^{t} , {y}_{τ 1}^{t} ) , {υ}_{2}^{t} = ( {x}^{t} , {y}_{τ 2}^{t} ) , {υ}_{3}^{t} = ( {x}^{t} , {y}_{τ 3}^{t} ) and {υ}_{4}^{t} = ( {x}^{t} , {y}_{τ 4}^{t} ) ,$$

as in the case of FIG. 4 the nodes are shown in FIG. 5 for simplicity. Between the first time period (t) and second time period (t+1), the fourth node (task 4, estimating future power consumption, indicated by a triangle in FIG. 5) becomes unavailable, for example, ceases functioning. The lack of availability may be a result of a ML agent hosting the relevant ML model (which may be part of the computing infrastructure) suffering a hardware failure, failure of a communication link, and so on. Accordingly, the values for the fourth node at time t+1 are not available. The values for the remaining three nodes (tasks 1, 2 and 3) are available at time t+1. The decoder ML model processes the initial edge graph and outputs reconstructions of all of the ML tasks at t+1. The loss function is then calculated using the known ML tasks data available for nodes 1, 2 and 3 (input into the decoder ML model as shown in FIG. 5) at time t+1, and the determined loss function is evaluated using a predetermined convergence criterion as discussed above.

The parameters of the encoder ML model and decoder ML model may then be updated as necessary, until the convergence criterion is satisfied. Once the convergence criterion is satisfied, the final KG (edge graph) may then be output. The output KG may then be used to infer the unknown values for the second time period; essentially the values for task 4 (estimating future power consumption) at time t+1 are estimated from the knowledge of the relations between task 4 and the other three tasks at that time. Accordingly, the method allows the outputting of known values where these are available, and inferred values where the known values are not available. In the FIG. 5 example, the outputs for t+1 may therefore be therefore

$${υ}_{1}^{t + 1} = ( {x}^{t + 1} , {y}_{τ 1}^{t + 1} )$$

(represented by a solid white circle in FIG. 5),

$${υ}_{2}^{t + 1} = ( {x}^{t + 1} , {y}_{τ 2}^{t + 1} )$$

(represented by a solid white star in FIG. 5),

$${υ}_{3}^{t + 1} = ( {x}^{t + 1} , {y}_{τ 3}^{t + 1} )$$

(represented by a solid white square in FIG. 5) and

$${\hat{υ}}_{4}^{t + 1} = ( {x}^{t + 1} , {\hat{y}}_{τ 4}^{t + 1} )$$

(represented by a dashed white triangle in FIG. 5), as shown in FIG. 5. Therefore, through use of the edge graph generated using the encoder ML model and decoder ML model, the estimated future power consumption may be inferred despite the ML model trained to complete this task being unavailable.

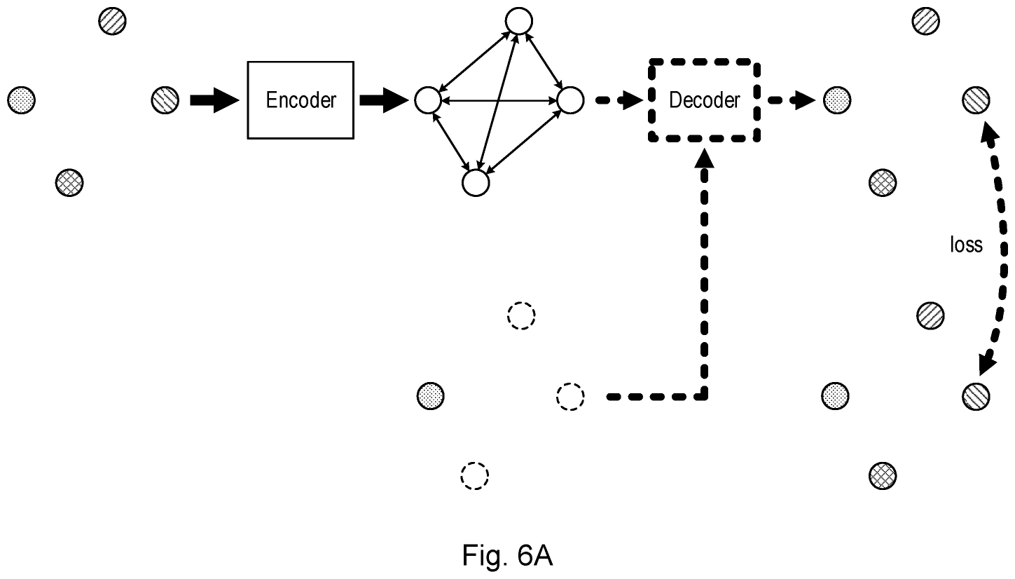

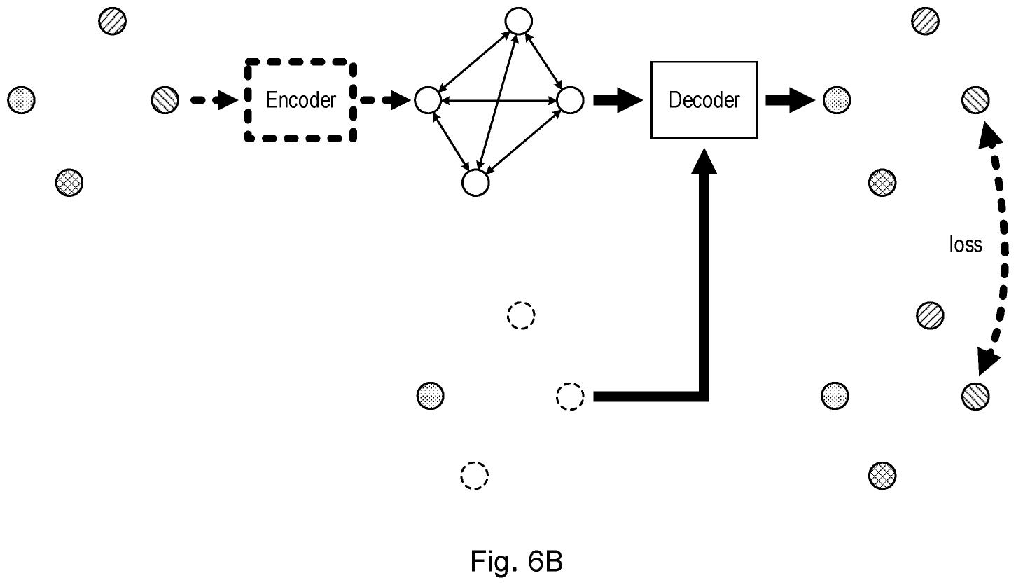

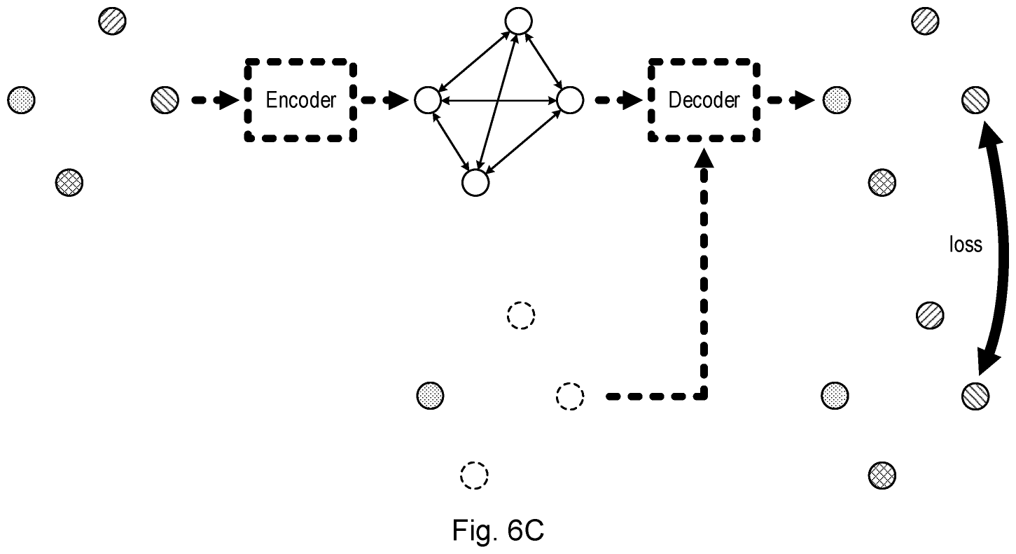

In the example shown in FIG. 5, the values for one of the ML tasks in relation to the second time period are not available. In some embodiments, the number of tasks for which values are not available (and should therefore be inferred) may be greater than one. FIG. 6A, FIG. 6B and FIG. 6C show a further embodiment in which values for a plurality of ML tasks are not available at a second time period.

In FIG. 6A, nodes

$${υ}_{1}^{t} = ( {x}^{t} , {y}_{τ 1}^{t} )$$

(dashed diagonal line shading in FIG. 6),

$${υ}_{2}^{t} = ( {x}^{t} , {y}_{τ 2}^{t} )$$

(dotted shading in FIG. 6),

$${υ}_{3}^{t} = ( {x}^{t} , {y}_{τ 3}^{t} )$$

(diagonal stripe shading in FIG. 6) and

$${υ}_{4}^{t} = ( {x}^{t} , {y}_{τ 4}^{t} )$$

(black and white square shading in FIG. 6) (the input data for all of which relates to a first time period t) are used to generate an initial edge graph by the encoder ML model. The initial edge graph is then decoded by the decoder ML model, using input data relating to a second time period t+1. During the training process, some of the nodes are treated as not available for model evaluation purposes (these nodes may also be referred to as obscured nodes) in relation to the second time period. In the example shown in FIG. 6B, only node

$${υ}_{1}^{t + 1}$$

is treated as available, the other three nodes are treated as not available (as indicated by the dashed lines outlines in the decoder input in FIG. 6B). The loss value between

$${υ}_{1}^{t + 1}$$

and the reconstructed

$${\hat{υ}}_{1}^{t + 1}$$

(and equivalent loss values for other reconstructed nodes, wherein the reconstructed nodes are indicated by dashed outlines at the decoder output) are then used to determine a loss value, which is evaluated (potentially using the nodes previously considered unavailable to determine the accuracy of the reconstruction, as illustrated in FIG. 6C) and, if the convergence criterion is not satisfied, used to update parameters of the encoder ML model and decoder ML model before the encoder ML model and decoder ML model are reapplied; this process is repeated until the convergence criterion is satisfied.

When the convergence criterion is satisfied, in an application scenario the values for nodes that are actually not available are then inferred using the final edge graph; the output therefore comprises the known values

$${υ}_{1}^{t + 1} = ( {x}^{t + 1} , {y}_{τ 1}^{t + 1} ) ,$$

and inferred values

$${\hat{υ}}_{2}^{t + 1} = ( {x}^{t + 1} , {\hat{y}}_{τ 2}^{t + 1} ) , {\hat{υ}}_{3}^{t + 1} = ( {x}^{t + 1} , {\hat{y}}_{τ 3}^{t + 1} ) and {\hat{υ}}_{4}^{t + 1} = ( {x}^{t + 1} , {\hat{y}}_{τ 4}^{t + 1} ) .$$

In embodiments where a greater percentage of the nodes are not available in the second time period, this may increase the number of iterations required to obtain a loss value that satisfies a convergence criterion. In some situations where a large number of nodes are not available, there may be insufficient information available to satisfy a convergence criterion, in which case the process may fail.

There now follows a discussion of some example use cases for present disclosure, as well as description of implementation of the present disclosure for such example use cases. It will be appreciated that the use cases presented herein are not exhaustive, but are representative of the type of problem within a computing infrastructure such as a communication network, data centre, or other computing infrastructure which may be addressed using the methods presented herein.

Embodiments of the present invention may allow a reduction in the amount of human input when selecting, for example, ML models for federation, source ML models for transfer learning, and so on; this may improve efficiency and may reduce the impact of perception bias. The KGs generated may help identify instance where negative results may arise from parameter transfers, for example. In other applications, the models may allow estimation of the outputs from unavailable ML models, which may help mitigate the impact of model failures. Further, as embodiments map the relations between tasks without the requirement for the presence of a ML model nor the actual transfer of training, the relations may be determined free from the influence of model architectural choice and not limited to homogeneous models necessary for transfer and few-shot learning.

### Use Case 1—QoS Monitoring Tasks in Communication Network

A first example use case is the generation of a KG representing relationships between Quality of Service (QoS) monitoring tasks in a communications network. In this use case, the computing infrastructure is all or part of a communications network (such as a 3GPP communications network comprising a plurality of base stations, for example), and the ML tasks are QoS monitoring tasks such as estimating future latencies, identifying potential future traffic bottlenecks, estimating future network resource usage, and so on. Embodiments may be used, where all of the QoS tasks initially have corresponding ML models, to estimate the values of a ML model that has become unavailable; for example if the ML model used to estimate future latencies becomes unavailable, the output of this model may be estimated using the other ML models for which outputs are available (such as the ML model used to identify potential future traffic bottlenecks and the ML model used to estimate future network resource usage). Additionally or alternatively, where there is no ML model trained or partially trained to perform one of the QoS monitoring tasks, transfer learning may be used and the initialization parameters for this model may be selected from one or more of the existing ML models for other tasks using the KG. The input data for the QoS monitoring tasks may comprise network metrics such as a current available capacity of one or more base stations (which may be 4^{th} Generation, 4G, Evolved Node Bs, eNB, or 5^{th} Generation, 5G, next Generation Node Bs, gNBs, for example), the amount of data in the base station buffers for onward transmission, the number of user equipments (UEs) connected to given base stations, and so on. The output data for the QoS monitoring tasks may comprise QoS values such as estimated latencies, identifiers for base stations which may potentially be traffic bottlenecks, and so on.

According to an example, there is provided a computer implemented method for generating a KG representing relationships between a plurality of QoS monitoring tasks relating to a communications network, wherein each QoS monitoring task among the plurality of QoS monitoring tasks is characterised by an input data set comprising network metrics and an output data set of QoS values, and wherein each QoS monitoring task among the plurality of QoS monitoring tasks utilises the same input data set comprising network metrics. The method comprises constructing a plurality of nodes representing the plurality of QoS monitoring tasks, wherein each of the QoS monitoring tasks among the plurality of QoS monitoring tasks is characterised by the same input data set comprising network metrics input into the QoS monitoring task and an output data set of QoS values from the QoS monitoring task. The method further comprises constructing a plurality of edges forming an edge graph and connecting the nodes among the plurality of nodes. The construction of the plurality of edges comprises: applying an encoder ML model to the plurality of nodes, wherein the encoder ML model processes the nodes among the plurality of nodes in turn in a pairwise fashion and outputs an initial edge graph that represents the relationships between the pairs of nodes; applying a decoder ML model to the initial edge graph, wherein the decoder ML model processes the initial edge graph in conjunction with input data and outputs reconstructions of ML tasks; calculating a loss function using known ML tasks corresponding reconstructed ML tasks; and evaluating the determined loss function using a predetermined convergence criterion, and, if the convergence criterion is not satisfied, updating parameters of the encoder ML model and decoder ML model to minimise a value of the loss function and reapplying the encoder ML model and decoder ML model. On satisfaction of the convergence criterion, the method further comprises outputting a final edge graph as the KG comprising the constructed edges. This output final edge graph may then be used as discussed above.

### Use Case 2—Data Centre Operational Monitoring

A second example use case is the generation of a KG representing relationships between data centre operational monitoring tasks. In this use case, the computing infrastructure is all or part of a data centre comprising a plurality of servers, switching units, power supplies, and so on, and the ML tasks are operational monitoring tasks such as power usage prediction, memory usage prediction, predicting apparatus failures, capacity requirement predictions, and so on. Embodiments may be used, where all of the operational monitoring tasks initially have corresponding ML models, to estimate the values of a ML model that has become unavailable; for example if the ML model used to predict power usage becomes unavailable, the output of this model may be estimated using the other ML models for which outputs are available (such as the ML model used to predict memory usage and the ML model used to make capacity requirement predictions). Additionally or alternatively, where there is no ML model trained or partially trained to perform one of the operational monitoring tasks, transfer learning may be used and the initialization parameters for this model may be selected from one or more of the existing ML models for other tasks using the KG. The input data for the operational monitoring tasks may comprise measurements of properties of the data centre, such as current processor usage for servers, current output of power supplies, available memory, temperature readings, and so on. The output data for the operational monitoring tasks may comprise predicted future data centre properties, such as predicted future memory requirements, identifiers for apparatuses at risk of imminent failure, and so on.

According to an example, there is provided a computer implemented method for generating a KG representing relationships between a plurality of operational monitoring tasks relating to a data centre, wherein each operational monitoring task among the plurality of operational monitoring tasks is characterised by an input data set comprising measurements of properties of the data centre and an output data set of predicted future data centre properties, and wherein each operational monitoring task among the plurality of operational monitoring tasks utilises the same input data set comprising measurements of properties of the data centre. The method comprises constructing a plurality of nodes representing the plurality of operational monitoring tasks, wherein each of the operational monitoring tasks among the plurality of operational monitoring tasks is characterised by the same input data set comprising measurements of properties of the data centre input into the operational monitoring task and an output data set of predicted future data centre properties from the operational monitoring task. The method further comprises constructing a plurality of edges forming an edge graph and connecting the nodes among the plurality of nodes. The construction of the plurality of edges comprises: applying an encoder ML model to the plurality of nodes, wherein the encoder ML model processes the nodes among the plurality of nodes in turn in a pairwise fashion and outputs an initial edge graph that represents the relationships between the pairs of nodes; applying a decoder ML model to the initial edge graph, wherein the decoder ML model processes the initial edge graph in conjunction with input data and outputs reconstructions of ML tasks; calculating a loss function using known ML tasks corresponding reconstructed ML tasks; and evaluating the determined loss function using a predetermined convergence criterion, and, if the convergence criterion is not satisfied, updating parameters of the encoder ML model and decoder ML model to minimise a value of the loss function and reapplying the encoder ML model and decoder ML model. On satisfaction of the convergence criterion, the method further comprises outputting a final edge graph as the KG comprising the constructed edges. This output final edge graph may then be used as discussed above.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A method for generating a Knowledge Graph (KG) representing relationships between a plurality of Machine Learning (ML) tasks relating to a computing infrastructure, wherein each ML task among the plurality of ML tasks is characterized by an input data set and an output data set, and wherein each ML task among the plurality of ML tasks utilizes the same input data set, the method comprising:
constructing a plurality of nodes representing the plurality of ML tasks, wherein each of the ML tasks among the plurality of ML tasks is characterized by the input data set to the ML task and an output data set from the ML task;
constructing a plurality of edges forming an edge graph and connecting the nodes among the plurality of nodes, wherein the construction of the plurality of edges comprises:
applying an encoder ML model to the plurality of nodes, wherein the encoder ML model processes the nodes among the plurality of nodes in turn in a pairwise fashion and outputs an initial edge graph that represents the relationships between the pairs of nodes;
applying a decoder ML model to the initial edge graph, wherein the decoder ML model processes the initial edge graph in conjunction with input data and outputs reconstructions of ML tasks;
calculating a loss function using known ML tasks corresponding reconstructed ML tasks; and
evaluating the determined loss function using a predetermined convergence criterion, and, if the convergence criterion is not satisfied, updating parameters of the encoder ML model and decoder ML model to minimise a value of the loss function and reapplying the encoder ML model and decoder ML model; and
on satisfaction of the convergence criterion, outputting a final edge graph as the KG comprising the constructed edges.

2. The method of claim 1, wherein the encoder ML model is a Graphical Neural Network (GNN) encoder ML model, and/or wherein the decoder ML model is a GNN decoder ML model.

3. The method of claim 1, wherein a loss calculator module is used to calculate the loss function.

4. The method of claim 1, wherein the loss function comprises a reconstructions loss and a regularization loss.

5-15. (canceled)

16. A computing apparatus configured to generate a Knowledge Graph (KG) representing relationships between a plurality of Machine Learning (ML) tasks relating to a computing infrastructure, wherein each ML task among the plurality of ML tasks is characterised by an input data set and an output data set, and wherein each ML task among the plurality of ML tasks utilises the same input data set, the computing apparatus comprising processing circuitry and a memory containing instructions executable by the processing circuitry, wherein the computing apparatus is operable to perform a method comprising:
constructing a plurality of nodes representing the plurality of ML tasks, wherein each of the ML tasks among the plurality of ML tasks is characterized by the input data set to the ML task and an output data set from the ML task;
constructing a plurality of edges forming an edge graph and connecting the nodes among the plurality of nodes, wherein the construction of the plurality of edges comprises:
applying an encoder ML model to the plurality of nodes, wherein the encoder ML model processes the nodes among the plurality of nodes in turn in a pairwise fashion and outputs an initial edge graph that represents the relationships between the pairs of nodes;
applying a decoder ML model to the initial edge graph, wherein the decoder ML model processes the initial edge graph in conjunction with input data and outputs reconstructions of ML tasks;
calculating a loss function using known ML tasks corresponding reconstructed ML tasks; and
evaluating the determined loss function using a predetermined convergence criterion, and, if the convergence criterion is not satisfied, updating parameters of the encoder ML model and decoder ML model to minimise a value of the loss function and reapplying the encoder ML model and decoder ML model; and
on satisfaction of the convergence criterion, outputting a final edge graph as the KG comprising the constructed edges.

17. The computing apparatus of claim 16, wherein the encoder ML model is a Graphical Neural Network (GNN) encoder ML model, and/or wherein the decoder ML model is a GNN decoder ML model.

18. The computing apparatus of claim 16, further configured to use a loss calculator module to calculate the loss function.

19. The computing apparatus of claim 16, wherein the loss function comprises a reconstructions loss and a regularization loss.

20. The computing apparatus of claim 16, further configured to use a convergence module to evaluate the determined loss function and, if the convergence criterion is not satisfied, to update parameters of the encoder ML model and decoder ML model.

21. The computing apparatus of claim 20, wherein the convergence module is configured to evaluate at least a current value of the loss function and a previous value of the loss function to determine whether the convergence criterion is satisfied.

22. The computing apparatus of claim 21, configured to compare an amount of change in the loss function between the current value of the loss function and previous value of the loss function to a predetermined threshold when determining whether the convergence criterion is satisfied.

23. The computing apparatus of claim 16, wherein the input data used by the decoder ML model when processing the initial edge graph is the same input data that is used to construct the plurality of nodes.

24. The computing apparatus of claim 23, further configured to utilise the output KG to identify at least a first ML task and a second ML task from among the plurality of ML tasks, wherein the first ML task and second ML task are closely related ML tasks.

25. The computing apparatus of claim 24, further configured to use a first ML model that has been trained to perform the first ML task as a source ML model to provide initialization parameters for a second ML model to be trained to perform the second ML task.

26. The computing apparatus of claim 16, wherein the input data used by the decoder ML model to process the initial edge graph relates to at least one of the plurality of nodes, and wherein the input data used by the decoder ML model relates to a second time period and the input data used in the construction of the plurality of nodes relates to a first time period that is different to the second time period.

27. The computing apparatus of claim 26, wherein the decoder ML model is configured to output reconstructions of ML tasks relating to the second time period.

28. The computing apparatus of claim 27, configured to calculate the loss function using known ML tasks relating to the second time period.

29. The computing apparatus of claim 28, further configured to utilise the output KG to infer unknown values for ML tasks relating to the second time period.

30. The computing apparatus of claim 29, wherein the second time period is after the first time period, and the unknown values are for ML tasks that have ceased to correctly operate between the first time period and second time period.

31. A non-transitory computer-readable medium storing instructions which, when executed on a computer, cause the computer to perform the method of claim 1.
